(19) United States
(12) Patent Application Publication
(10) Pub. No.: US 2026/0349915 A1
(43) Pub. Date: Nov. 5, 2026

(54) Adapting SSDs To CXL Fabric Using UIO With Isolated Read Paths

(71) Applicant: Sandisk Technologies, Inc., Milpitas, CA (US)

(72) Inventor: Shay BENISTY, Beer Sheva (IL)

(73) Assignee: Sandisk Technologies, Inc., Milpitas, CA (US)

(21) Appl. No.: 19/071,407

(22) Filed: Mar. 5, 2025

(51) Int. Cl. G06F 12/02

(52) U.S. Cl. CPC G06F 12/0246

(57) ABSTRACT

Out of order completions can create problems for controllers in solid state drives (SSDs) in terms of quality of service (QOS). The controller therefore reorders completions to ensure the completions are in the correct order before sending to the memory device. Peripheral component interconnect (PCI) express (PCle) unordered input/output (UIO) and compute express link (CXL) adds further complexity for controllers, but UIO can be beneficial in a CXL fabric situation. UIO allows a SSD to be able to handle both UIO transactions as well as non-UIO transactions. To effectively handle the two different types of transactions, the controller can have two isolated read paths, each with a corresponding reordering buffers, one for UIO transactions and one for non-UIO transactions. The isolated read paths for UIO and non-UIO transactions improves usage of CXL memory in SSDs.

### BACKGROUND OF THE DISCLOSURE

### Field of the Disclosure

Embodiments of the present disclosure generally relate to improved usage of CXL memory.

### Description of the Related Art

Compute Express Link (CXL) is an industry-standard interconnect designed to facilitate high-speed, low-latency communication between central processing units (CPUs) and other devices such as accelerators, memory buffers, and smart input/output (I/O) devices. CXL aims to improve the performance and efficiency of data centers and other high-performance computing environments.

CXL includes three sub-protocols: CXL.io—for peripheral component interconnect (PCI) express (PCle)-based I/O operations; CXL.cache—for memory coherency between the host and the device; and CXL.memory—for direct memory access, allowing devices to share memory with the host CPU. CXL is particularly important in modern data centers where heterogeneous computing environments require efficient communication between various components to maximize performance and resource utilization.

New solid state drives (SSDs) can be designed with CXL in mind. Legacy SSDs, however, may not be properly equipped to handle CXL. Therefore, there is a need in the art for an improved usage of CXL memory.

### SUMMARY OF THE DISCLOSURE

Out of order completions can create problems for controllers in solid state drives (SSDs) in terms of quality of service (QOS). The controller therefore reorders completions to ensure the completions are in the correct order before sending to the memory device. Peripheral component interconnect (PCI) express (PCle) unordered input/output (UIO) and compute express link (CXL) adds further complexity for controllers, but UIO can be beneficial in a CXL fabric situation. UIO allows a SSD to be able to handle both UIO transactions as well as non-UIO transactions. To effectively handle the two different types of transactions, the controller can have two isolated read paths, each with a corresponding reordering buffers, one for UIO transactions and one for non-UIO transactions. The isolated read paths for UIO and non-UIO transactions improves usage of CXL memory in SSDs.

In one embodiment, a data storage device comprises: a memory device; and a controller coupled to the memory device, wherein the controller is configured to: receive completed transactions on an interface, wherein the completed transactions are out of order; queue the completed transactions into two or more reordering buffers; and sequentially retrieve data from the two or more reordering buffers.

In another embodiment, a data storage device comprises: a memory device; and a controller coupled to the memory device, wherein the controller is configured to: operate with two isolated read paths, wherein a first read path of the two isolated read paths is for unordered input/output (UIO) transactions and a second read path of the two isolated read paths is for non-UIO transactions; determine that a single read command utilizes the first read path and the second read path; disable operating the two isolated read paths; and operate with a single read path.

In another embodiment, a data storage device comprises: means for storing data; and a controller coupled to the means for storing data, wherein the controller is configured to: receive an unordered input/output (UIO) transaction from a compute express link (CXL) memory in a first reordering buffer; receive a non-UIO transaction from a host device in the first reordering buffer; determine whether the UIO transaction and the non-UIO transaction are in order; reorder the UIO transaction and the non-UIO transaction; and send the UIO transaction and the non-UIO transaction to the means to store data.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of the compute express link (CXL) protocol.

FIG. 3 is schematic illustration of the CXL fabric with unordered input/output (UIO).

FIG. 4 is a schematic illustration of using a single reordering completion buffer for processing UIO transactions and non-UIO transactions.

FIG. 5 is a flowchart illustrating processing using the schematic illustration of FIG. 4.

FIG. 6 is a schematic illustration of isolated read paths for UIO and non-UIO transactions according to one embodiment.

FIG. 7 is a flowchart illustrating processing using the schematic illustration of FIG. 6.

FIG. 8 is a flowchart illustrating processing a single command that attempts to utilize both UIO and non-UIO transactions.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Out of order completions can create problems for controllers in solid state drives (SSDs) in terms of quality of service (QOS). The controller therefore reorders completions to ensure the completions are in the correct order before sending to the memory device. Peripheral component interconnect (PCI) express (PCle) unordered input/output (UIO) and compute express link (CXL) adds further complexity for controllers, but UIO can be beneficial in a CXL fabric situation. UIO allows a SSD to be able to handle both UIO transactions as well as non-UIO transactions. To effectively handle the two different types of transactions, the controller can have two isolated read paths, each with a corresponding reordering buffers, one for UIO transactions and one for non-UIO transactions. The isolated read paths for UIO and non-UIO transactions improves usage of CXL memory in SSDs.

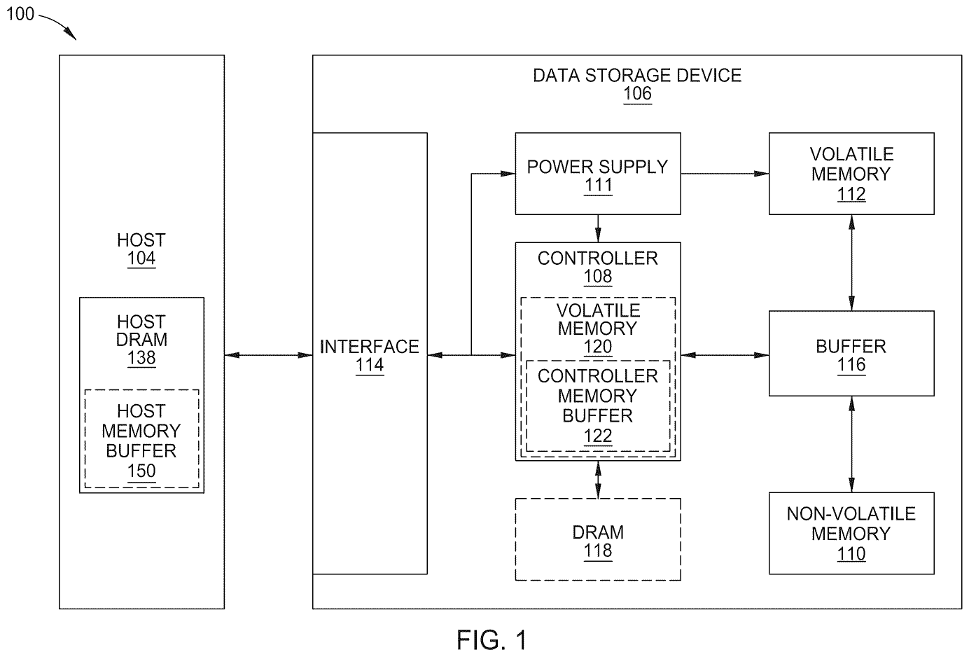

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCle) (e.g., PCle x1, x4,x8, x16, PCle Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCle, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

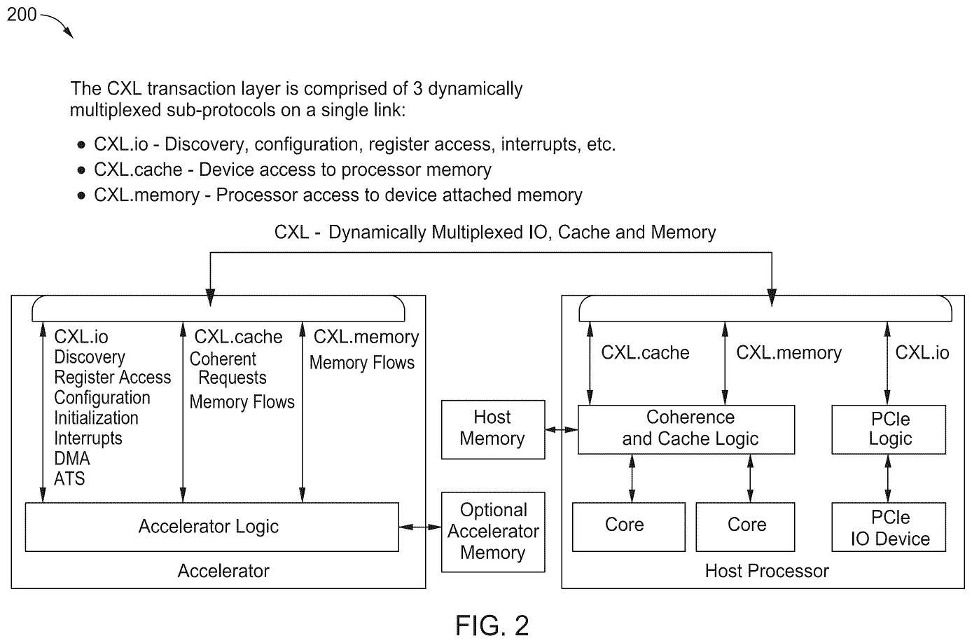

FIG. 2 is a schematic illustration 200 of the compute express link (CXL) protocol. CXL is a new protocol which is based on PCle, but with a focus on latency. The CXL standard defines new transactions over the PCle link in order to minimize the latency. The CXL standard, as shown in FIG. 2, defines three dynamically multiplexed sub-protocols or features on a single link. The first feature is CXL. io which is basically PCle. CXL.io defines the discovery, configuration, register access, interrupts, initialization, DMA, ATS, etc. The second feature is CXL.cache which has features that are related to device access to processor memory, such as coherence requests, memory flows, etc. The third feature is CXL.memory which is processor access to device attached memory which is basically load and store operations over the link such as memory flows.

There is a new industry standard feature called PCle UIO. In UIO, PCle defines a new traffic class which means all the transactions that will go with the UIO feature would be in a different traffic class. Therefore UIO is unordered because there are no ordering rules between the regular traffic class and the UIO traffic class. UIO can be equated to a logically separate link, but of course shares the same physical link. However, logically, UIO can be thought about as a different link and therefore no reorder rules between the regular transactions and the UIO. The UIO feature enables using a regular SSD with PCle that supports only PCle features and not CXL, but supports the PCle UIO.

UIO enhances performance by allowing I/O operations to be executed out of order. UIO approach improves throughput and reduces latency by enabling multiple operations to be processed concurrently, optimizing resource utilization. UIO is particularly beneficial for high-performance computing environments and devices like SSDs, GPUs, and network interfaces that require efficient and fast data transfer.

A or legacy SSD may have two parallel paths: the legacy path to the host, and also the PCle UIO path where the SSD interacts directly peer-to-peer (P2P) with the CXL memory, which will cause some challenges. The challenges for the SSD, because the two separate paths are different attributes, are for example: different latency and different performance, which is a challenge. As discussed herein, the SSD can utilize a UIO path and a non-UIO path where the UIO path interacts directly with the CXL memory without the host device while the non-UIO path interacts with the host device.

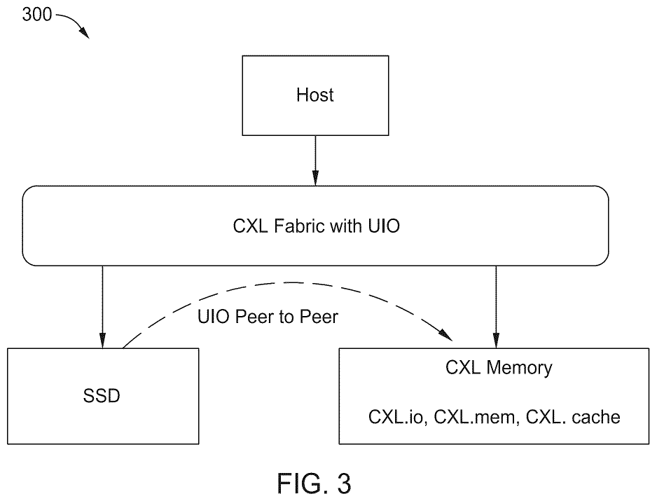

FIG. 3 is schematic illustration 300 of the CXL fabric with UIO. FIG. 3 demonstrates communication between a NVMe SSD with UIO and a CXL memory device. The host device uses the CXL memory for input/output (I/O) data buffers and intends to write to the SSD storage. However, due to UIO enablement in the SSD, as well as in the CXL switch and computational processor, the storage write can be performed directly P2P without involving the host device.

Without the UIO support, the SSD needs to access the host device components which converts PCle to CXL transactions and sends the CXL transactions to CXL Memory through the CXL fabric. The CXL memory sends the responses back to the host device through the CXL fabric which needs to generate modified responses and sends the responses to the SSD, which is an inefficient solution compared to the UIO method.

Alternatively, the SSD can interact with the host subsystem using PCle transactions and with the CXL memory using UIO transactions. The turnaround time for CXL memory access differs from that for host device access. As will be discussed below, the instant disclosure addresses the problem introduced by having two separate paths for data transfer (i.e., UIO and non-UIO) and discloses a method by which the SSD can achieve full isolation between these paths while minimizing the impact of the interaction.

The illustration 300 shows the CXL fabric with the PCle UIO feature. The illustration includes the host device, CXL fabric with UIO, SSD, and CXL memory. The CXL memory supports, in general, the CXL.IO, CXL.cache, and CXL.memory. If the SSD does not support the UIO feature, the SSD ensures all the interactions between the SSD and the other components in the system must go through the host device. Because the SSD just knows to generate PCle packets, the SSD will need to interact with the host device. The host device will need to convert those PCle packets to CXL, interact with the CXL memory, receive the results, and then send the results back to the SSD. Such a process is inefficient. Thanks to the UIO feature, even though the SSD does not support native CXL features, but does support the UIO feature, the SSD will be able to interact directly with the CXL memory without interacting with the host device.

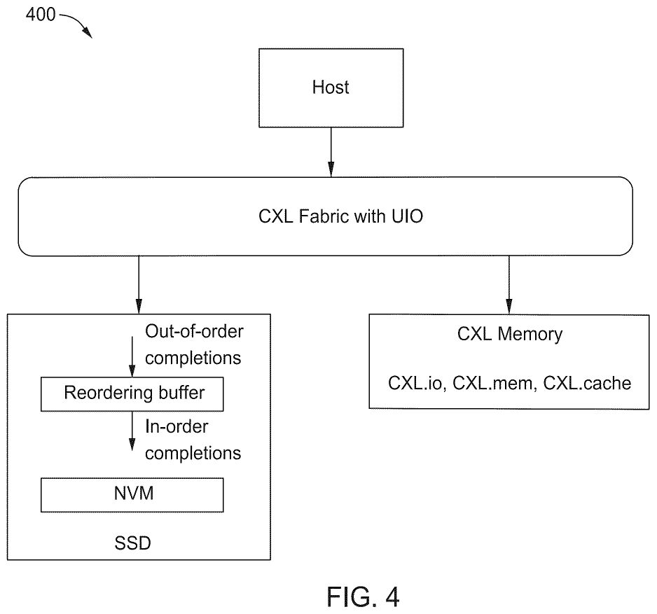

FIG. 4 depicts a straightforward solution. FIG. 4 is a schematic illustration 400 of using a single reordering completion buffer for processing UIO transactions and non-UIO transactions. In a SSD, a reordering read buffer is incorporated in the PCle layer of the storage device. The reordering read buffer is required since when reading data over PCle bus, the data may be returned out-of-order. The reordering buffer simplifies the implementation of the data storage device. In the approach shown in FIG. 4, the device controller may send non-UIO transactions towards the host device and UIO transactions towards CXL memory in-parallel. The reordering buffer orders the completions so the internal logic of the storage device receives the data in-order.

A single reordering buffer as shown in FIG. 4 will work, but will also introduce a problem due to the different attributes associated with UIO and non-UIO transactions. In the SSD, there is a reordering buffer. The reordering buffer is present because even for PCle, even for a single traffic class when the ordering is well defined, there will still be some out of order transactions. There are some ordering rules, but the ordering rules do not mean that everything is in order. There will be some out of order transactions. Therefore, in order to simplify the back end of the SSD, at the entrance of the PCle component internally in the SSD, there is the reordering buffer.

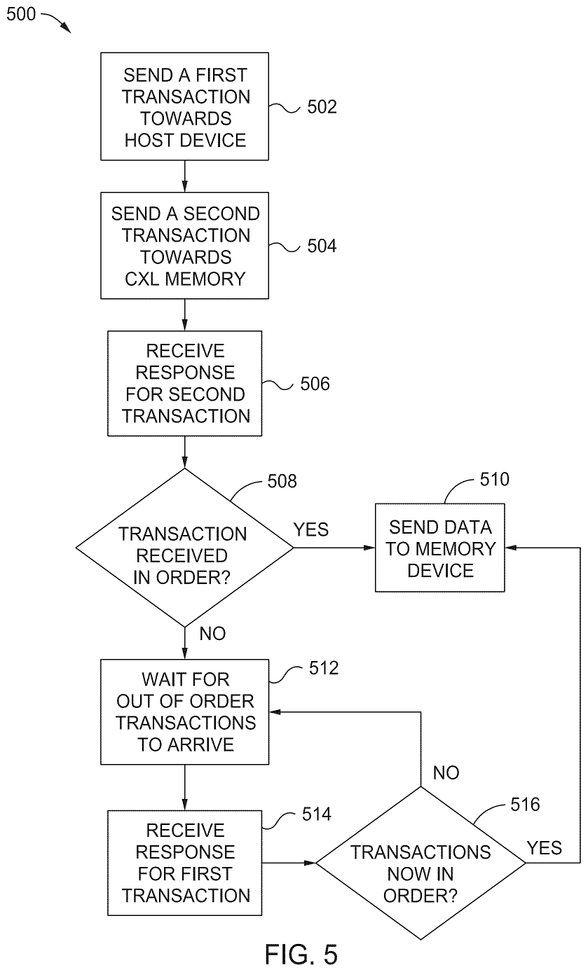

FIG. 5 is a flowchart 500 illustrating processing using the schematic illustration of FIG. 4. Initially, a first transaction (i.e., a non-UIO transaction) is sent towards a host device at block 502 followed by a second transaction (i.e., a UIO transaction) being sent towards CXL memory at block 504. Overall, the data storage device will send transactions to both the host device and the CXL memory continuously and in parallel based upon data needs. Thereafter, a response is received for the second transaction at block 506 followed by a determination if the received transactions at the reordering buffer are in order at block 508. If the transactions in the reorder buffer are in order, then the data is sent to the memory device at block 510. However, if the transactions in the reorder buffer are not in order, likely due to a transaction not yet being received from the host device, then the data storage device waits for out of order transactions to arrive at the reorder buffer at block 512. While waiting, the response for the first transaction is received at block 514 and a determination is made at block 516 regarding whether the transactions are now in order in the reorder buffer. If the transactions are in order, then the process proceeds to block 510, but if there are still transactions out there (i.e., the transactions are not in order), then the process proceeds to block 512.

In the reordering buffer there will be out of order completions from the host device and then after the reordering buffer everything will be in order. The SSD is going to interact with both the host device and the CXL memory, and everything would be held in the reordering buffer. However, the reordering buffer is not enough to sustain the performance because the reordering buffer will increase the latency because the attributes of one path (i.e., to/from host device) are not equal to the attribute of the other path (i.e., to/from CXL memory). Therefore, in order to still achieve the same performance, one or more additional reordering buffer are used.

The main drawback of the approach of FIGS. 4 and 5 is that non-UIO and UIO transactions have different attributes since the destinations and used protocol are not the same. For example, the turnaround time might be different. Having a single reordering buffer will increase the impact caused by the two different paths, but the single reordering buffer will word. For instance, CXL memory may have a turnaround time of X while the host device may have a turnaround time of Y while Y>>X. Having a single reordering buffer increases the latency when accessing the host device.

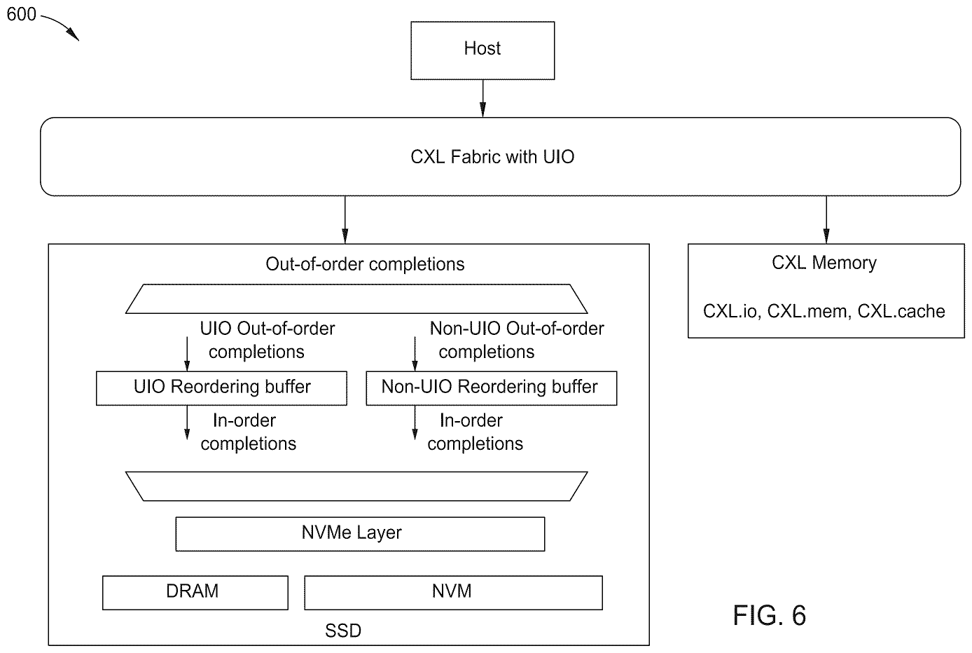

A better solution discussed herein, at a very high level, is to have a multiple, for example two, reordering buffers. There will be the legacy reordering buffer, but in this case the reordering buffer is to be used only for non-UIO transactions. All non-UIO transactions would go through the path on the right side of FIG. 6 through the non-UIO reordering path and there will be another reordering buffer which will be used only for non-UIO transactions. In this path all the UIO transaction that will come from the CXL will go to on the path through the UIO reordering buffer. The mux determines whether to go down the UIO or non-UIO buffer path.

In order to simplify things, the mux that is responsible for pulling the data from the reordering buffers includes a small scheduler that will define the next data to be taken from a path. In order to simplify the solution, the granularity would be 4K in one embodiment. If the decision is made to pull data from the new non-UIO reordering buffer, the mux will pull several transaction but will stop pulling from the non-UIO reordering buffer only after having 4K. Then the mux will decide whether to pull the next data from the non-UIO reordering buffer or from the UIO reordering buffer. The granularity could theoretically have less granularity, but such a configuration would add extra complexity to the internal solution of the SSD. Therefore, it is better to work on 4K granularity. Additionally, the mux will probably need to see if the non-UIO buffer has a chunk of data of at least 4K and only then will the non-UIO buffer be considered as a candidate for the arbitration. Otherwise, there is no value in considering the path in the arbitration because the arbitration would work in 4K granularity.

The disclosure introduces a method for SSDs to manage data transfer paths between CXL memory and the host subsystem effectively. The SSD interacts with the host subsystem using PCle transactions and with CXL memory using UIO transactions, which have different turnaround times and protocol characteristics. To address the challenges posed by the differences, the disclosure implements full isolation of the data transfer paths.

The method involves using separate reordering buffers for each transaction type, ensuring that the varying turnaround times of CXL memory (X) and host system (Y, where Y>>X) do not interfere with each other. By isolating these paths, the disclosure minimizes latency and eliminates potential head-of-line blocking that can occur when transactions with different attributes are processed in a single buffer. The separation ensures that the SSD can handle both CXL and host transactions efficiently, enhancing performance and reliability.

FIG. 6 is a schematic illustration 600 of isolated read paths for UIO and non-UIO transactions according to one embodiment. FIG. 6 illustrates the architecture of the disclosure, highlighting the separation of reordering buffers for UIO and non-UIO transfers. In the setup of FIG. 6, two distinct reordering buffers are utilized: one dedicated to UIO transactions and the other to non-UIO transactions. FIG. 6 demonstrates how completion transactions arrive on the PCle interface in an out-of-order fashion. A specialized logic unit is responsible for queuing the completions into respective reordering buffers based on transaction type. Data is then sequentially retrieved from each reordering buffer, maintaining the internal order of transactions within each buffer but allowing independent processing order between UIO and non-UIO transactions. The design ensures efficient data handling and minimizes latency by isolating the paths and managing them separately. The two isolated paths are finally converged in the NVMe layer for simplicity. The atomicity is still LBA size, otherwise, extra complexity is added while the value is low.

More specifically as shown in FIG. 6, the SSD has two mux within the controller. One mux is disposed between the NVMe layer and the reordering buffers. The other mux is disposed between the reordering buffers and the CXL fabric. The two mux and reordering buffers are disposed in the controller.

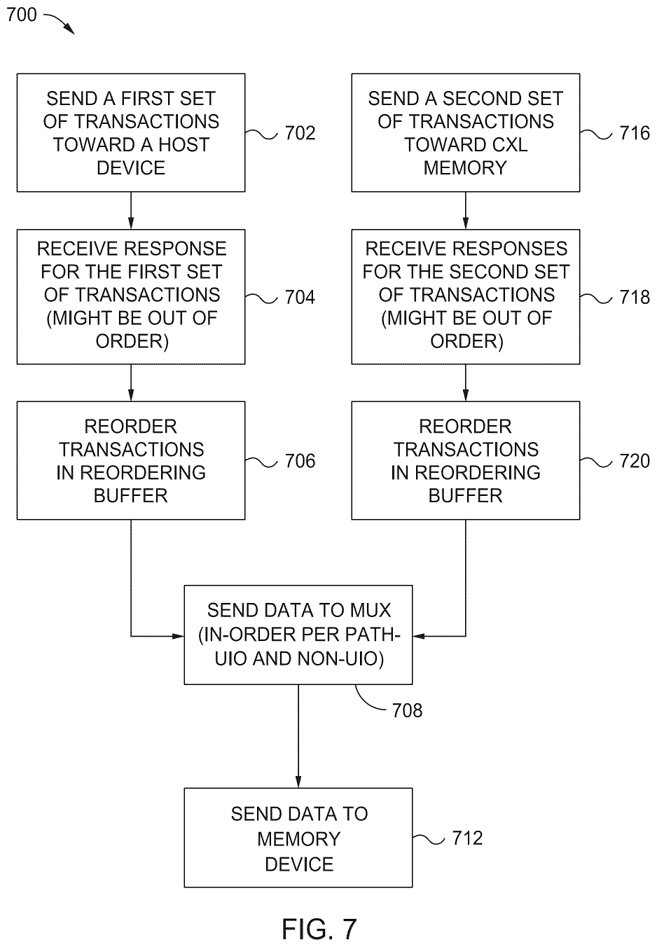

FIG. 7 is a flowchart 700 illustrating processing using the schematic illustration of FIG. 6. Initially, a first set of transactions is sent towards the host device at block 702. The first set of transactions are non-UIO transactions. Thereafter, responses are received for the first set of transactions at block 704. The responses might be out of order. The transactions are reordered in the non-UIO reordering buffer at block 706. The data is then sent to the mux at block 708. In block 708, the data is received in order for the non-UIO transactions.

In parallel, a second set of transactions is sent towards the CXL memory at block 716. The second set of transactions are UIO transactions. Thereafter, responses are received for the second set of transactions at block 718. The responses might be out of order. The transactions are reordered in the UIO reordering buffer at block 720. The data is then sent to the mux at block 708, and the data is received in order for the UIO transactions. Once the data is in the mux, the data is sent to the memory device at block 712.

The two separate paths work well when a single NVMe command utilizes either the UIO or non-UIO paths. However, when a single command mixes these paths, the approach becomes very complex. In one embodiment, the two isolated paths are automatically disabled upon detecting a mixture of UIO and non-UIO transfers within a single command. In the scenario, the data storage device reverts to using a single reordering buffer for all transfers.

Even after disabling the two isolated paths mode, the data storage device may decide to revert to the mode under certain circumstances to regain the benefits. The data storage device may consider the following: power cycle; reset cycle; time passed from last switch; and detection that no mixtures between UIO and non-UIO transfers within a command in making the decision to revert.

Another complexity that might occur is that if the host for a single NVMe command would decide to use mixed transfers. For example, for one NVMe read command, part of the transfer would be non-UIO and part of the transfers would be in UIO. In that case, there would be extra complexity in the device. Therefore, the controller would disable the two reordering buffer operation once the controller detects a command that we tries to utilize both paths in parallel.

In scenario discussed above, the controller would clean the pipes and then disable one path so that instead of having two isolated paths, there will just be one path with a single buffer. As to a preference on which buffer is to be used, one buffer can be chosen as a default. The preferred path would be based upon the size of the buffers, which impacts latency. The preferred default choice would be the larger buffer. When the controller detects the special command trying to use two paths, the controller will clean the pipes, then disable one buffer and decide to work with just one buffer. From time to time, the controller will reevaluate the decision because maybe it would be better to work again with the two reordering buffers. The reevaluation may occur, for example, after power cycle, after reset cycle, if a predetermined time has passed from the last switch, or detecting for a very long time that there is no mixture anymore in the system. In that scenario, the controller will decide again whether to go back to using the two buffers or still continue with the single buffer.

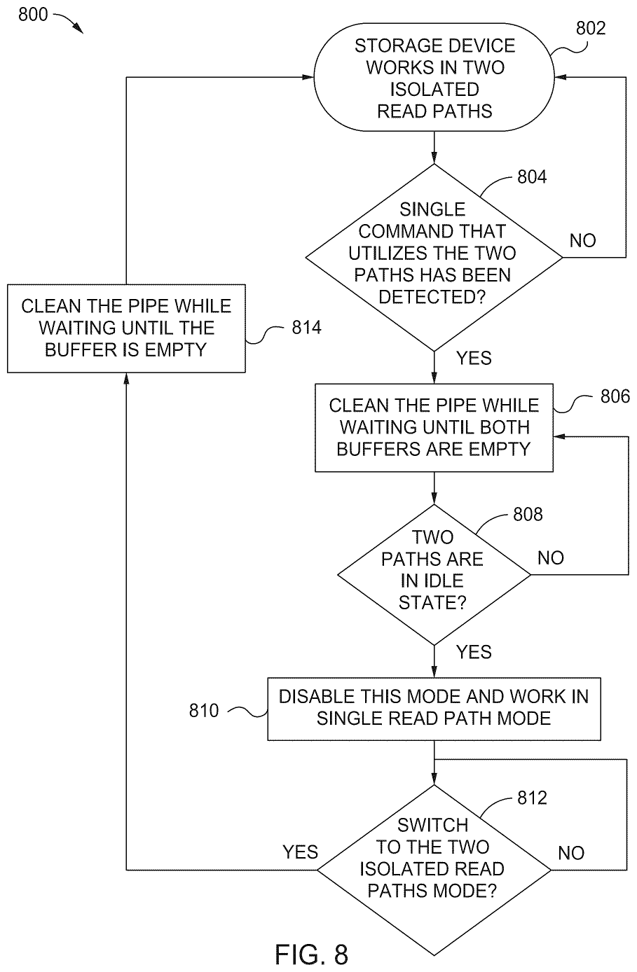

FIG. 8 is the flow chart 800 that describes the flow. The flow starts by using the two isolated read paths and then detecting that there is a single command that utilizes the two paths in parallel. Then the controller will clean the pipes while waiting until both buffers are empty. Then the controller disable the two buffer mode and select only one reordering buffer and work in single buffer mode. After some time, maybe after a power down, a timer, etc., the controller may decide to switch again to the two reordering buffers. The controller will then clean the pipes and make sure that everything is in the idle state and then reconfigure the two reordering buffers.

More specifically with regards to FIG. 8, FIG. 8 illustrates processing a single command that attempts to utilize both UIO and non-UIO transactions. Initially, the data storage devices works in two isolated read paths at block 802. Thereafter, a determination is made whether a single command utilizes the two paths has been detected at block 804. If no such command is detected, then the process proceeds back to block 802. However, if such a command is detected, then the pipes are cleaned while waiting for both buffers to empty at block 806. A determination is then made at block 808 regarding whether the two paths are in the idle state. If not in idle state, then the process proceeds to block 806. If the two paths are in the idle state, then the data storage device disables working in the two isolated read path mode at block 810 and operates in a single read path mode. At a later point in time, the data storage device makes a determination regarding whether to switch to the two isolated read path mode at block 812. If the determination is to not switch, then the process circles at block 812. However, is the determination is to switch, then the data storage device cleans the pipe while waiting for the reordering buffer to empty at block 814 followed by returning to block 802.

In another embodiment, a smart scheduler is incorporated before entering the NVMe layer to select the next winner between UIO and non-UIO paths. The scheduling decision may depend on factors such as buffer levels, priority, QOS, and LBA granularity. So instead of the mux making the decision which is more of a static decision, there are added more and more parameters. The con is the complexity, but the plus is that there will be better QoS and performance.

By using the ability to achieve full-path isolation between the CXL memory and the host system, the disclosure ensures that data transfer paths do not interfere with each other. The isolation optimizes performance by allowing the SSD to handle CXL and host device transactions independently, thereby minimizing latency. By separating the reordering buffers, the disclosure effectively removes potential head-of-line blocking, which can occur when transactions with differing turnaround times are processed together. As a result, the SSD can access the host system more efficiently and reliably, providing a significant performance boost and enhancing overall system responsiveness.

In one embodiment, a data storage device comprises: a memory device; and a controller coupled to the memory device, wherein the controller is configured to: receive completed transactions on an interface, wherein the completed transactions are out of order; queue the completed transactions into two or more reordering buffers; and sequentially retrieve data from the two or more reordering buffers. The sequentially retrieving maintains an internal order of the completed transactions within each buffer of the two or more buffers. The sequentially retrieving allows for independent processing order between two different transaction types. A first reordering buffer of the two or more reordering buffers is an unordered input/output (UIO) buffer. A second reordering buffer of the two or more reordering buffers is a non-UIO buffer. The controller is configured to direct CXL transactions to the UIO buffer. The controller includes a first multiplexer (mux) and a second mux. The first mux is disposed between the two or more reordering buffers and the memory device. The second mux is disposed between the two or more reordering buffers and a compute express link (CXL) fabric. The controller is configured to switch between using: a single buffer of the two or more reordering buffers; and multiple buffers of the two or more reordering buffers.

In another embodiment, a data storage device comprises: a memory device; and a controller coupled to the memory device, wherein the controller is configured to: operate with two isolated read paths, wherein a first read path of the two isolated read paths is for unordered input/output (UIO) transactions and a second read path of the two isolated read paths is for non-UIO transactions; determine that a single read command utilizes the first read path and the second read path; disable operating the two isolated read paths; and operate with a single read path. The controller is configured to complete in process read commands before the disabling. The controller is configured to empty a first buffer associated with the first read path, and wherein the controller is configured to empty a second buffer associated with the second read path. The controller is configured to switch back to operating the two isolated read paths. The switching occurs in response to a power cycle, a reset cycle, a predetermine time having passed, or a detection that there are no mixtures between UIO and non-UIO transfers within any commands. The controller comprises a scheduler disposed for selecting between the first read path and the second read path. The first read path comprises a UIO reordering buffer, and wherein the second read path comprises a non-UIO reordering buffer.

In another embodiment, a data storage device comprises: means for storing data; and a controller coupled to the means for storing data, wherein the controller is configured to: receive an unordered input/output (UIO) transaction from a compute express link (CXL) memory in a first reordering buffer; receive a non-UIO transaction from a host device in the first reordering buffer; determine whether the UIO transaction and the non-UIO transaction are in order; reorder the UIO transaction and the non-UIO transaction; and send the UIO transaction and the non-UIO transaction to the means to store data. The controller is configured to switch to isolated read paths, wherein the isolated read paths comprises a first read path for processing UIO transactions, and wherein the isolated read paths comprises a second read path for processing non-UIO transactions. The controller comprises a second reordering buffer and wherein the first reordering buffer is larger than the second reordering buffer.

While the foregoing is directed to embodiments of the present disclosure, other and further embodiments of the disclosure may be devised without departing from the basic scope thereof, and the scope thereof is determined by the claims that follow.

1. A data storage device, comprising:
a memory device; and
a controller coupled to the memory device, wherein the controller is configured to:
receive completed transactions on an interface, wherein the completed transactions are out of order;
queue the completed transactions into two or more reordering buffers; and
sequentially retrieve data from the two or more reordering buffers, wherein data retrieved from each of the two or more reordering buffers converges at an NVMe layer in order.

2. The data storage device of claim 1, wherein the sequentially retrieving maintains an internal order of the completed transactions within each buffer of the two or more buffers.

3. The data storage device of claim 2, wherein the sequentially retrieving allows for independent processing order between two different transaction types.

4. The data storage device of claim 1, wherein a first reordering buffer of the two or more reordering buffers is an unordered input/output (UIO) buffer.

5. The data storage device of claim 4, wherein a second reordering buffer of the two or more reordering buffers is a non-UIO buffer, wherein the no-UIO buffer is a buffer corresponding to a legacy path to a host device.

6. The data storage device of claim 5, wherein the controller is configured to direct CXL transactions to the UIO buffer.

7. The data storage device of claim 1, wherein the controller includes a first multiplexer (mux) and a second mux.

8. The data storage device of claim 7, wherein the first mux is disposed between the two or more reordering buffers and the memory device.

9. The data storage device of claim 8, wherein the second mux is disposed between the two or more reordering buffers and a compute express link (CXL) fabric.

10. The data storage device of claim 1, wherein the controller is configured to switch between using:
a single buffer of the two or more reordering buffers; and
multiple buffers of the two or more reordering buffers.

11. A data storage device, comprising:
a memory device; and
a controller coupled to the memory device, wherein the controller is configured to:
operate with two isolated read paths, wherein a first read path of the two isolated read paths is for unordered input/output (UIO) transactions and a second read path of the two isolated read paths is for non-UIO transactions, wherein the non-UIO transactions correspond to a legacy path to a host device;
determine that a single read command utilizes the first read path and the second read path;
disable operating the two isolated read paths, wherein the disabling is based on the determining; and
operate with a single read path.

12. The data storage device of claim 11, wherein the controller is configured to complete in process read commands before the disabling.

13. The data storage device of claim 12, wherein the controller is configured to empty a first buffer associated with the first read path, and wherein the controller is configured to empty a second buffer associated with the second read path.

14. The data storage device of claim 11, wherein the controller is configured to switch back to operating the two isolated read paths.

15. The data storage device of claim 14, wherein the switching occurs in response to a power cycle, a reset cycle, a predetermine time having passed, or a detection that there are no mixtures between UIO and non-UIO transfers corresponding to a legacy path to a host device within any commands.

16. The data storage device of claim 11, wherein the controller comprises a scheduler disposed for selecting between the first read path and the second read path.

17. The data storage device of claim 11, wherein the first read path comprises a UIO reordering buffer, and wherein the second read path comprises a non-UIO reordering buffer corresponding to a legacy path to a host device.

18. A data storage device, comprising:
means for storing data; and
a controller coupled to the means for storing data, wherein the controller is configured to:
receive an unordered input/output (UIO) transaction from a compute express link (CXL) memory in a first reordering buffer;
receive a non-UIO transaction corresponding to a legacy path to a host device from the host device in the first reordering buffer;
determine whether the UIO transaction and the non-UIO transaction are in order;
reorder the UIO transaction and the non-UIO transaction; and
send the UIO transaction and the non-UIO transaction corresponding to a legacy path to a host device to the means to store data, wherein data associated with the UIO transaction and the non-UIO transaction converges at an NVMe layer in order.

19. The data storage device of claim 18, wherein the controller is configured to switch to isolated read paths, wherein the isolated read paths comprises a first read path for processing UIO transactions, and wherein the isolated read paths comprises a second read path for processing non-UIO transactions corresponding to a legacy path to a host device.

20. The data storage device of claim 18, wherein the controller comprises a second reordering buffer and wherein the first reordering buffer is larger than the second reordering buffer.
